(19) United States
(12) Patent Application Publication
(10) Pub. No.: US 2025/0379530 A1
(43) Pub. Date: Dec. 11, 2025

(54) SAFETY DEVICE AND METHOD FOR EMERGENCY BRAKING OF ROBOTIC EXOSKELETON AND COMPUTER-READABLE STORAGE MEDIUM

(71) Applicant: FUTRONICS (NA) CORPORATION, PASADENA, CA (US)

(72) Inventors: Yunfei Guo, Pasadena, CA (US); Fulan Li, Pasadena, CA (US); Baiyu Wang, Pasadena, CA (US); Wenda Xu, Pasadena, CA (US); Weide Zhang, Pasadena, CA (US); Fangyun Zhao, Pasadena, CA (US); Chengkun Zhang, Pasadena, CA (US)

(21) Appl. No.: 18/737,995

(22) Filed: Jun. 8, 2024

(51) Int. Cl. H02P 3/22; B25J 9/00

(52) U.S. Cl. CPC H02P 3/22; B25J 9/0006

(57) ABSTRACT

A safety device is electrically connected to a motor of a robotic exoskeleton for implementing emergency stop of the robotic exoskeleton. The safety device includes a safety controller; a relay module electrically connected to the safety controller and three-phase power lines of the motor; and an emergency braking activation device electrically connected to the safety controller. The safety controller is to send a first relay control signal to the relay module in response to receiving a braking signal sent by the emergency braking activation device, and the first relay control signal is to control the relay module to short-circuit the three-phase power lines of the motor to brake the motor.

### TECHNICAL FIELD

The present disclosure generally relates to robots, and in particular relates to a safety device and method for emergency braking of robotic exoskeleton and computer-readable storage medium.

### BACKGROUND

Robotic exoskeleton has started to become a recent trend in rehabilitation, specifically in upper and lower extremity rehabilitation. The development of exoskeleton requires a delicate balance of weight, power, human experience, motion and others. Exoskeletons are employed in physical therapy rehabilitation to help improve muscle control and prevent muscle atrophy in disabled patients.

Motors are the heart of the exoskeleton. Many commercially available brushless motors do not come with brake system. Traditional methods focus on installing a brake system inside the motor box. In order to implement brake system, additional customizations need to be installed, which includes redesign of the mechanical structure, and re-assemble the motor. Often it takes a long development time, and high cost. It also increases the structure weight significantly, which can cause difficulties in development of exoskeleton.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic isometric view of a robotic exoskeleton according to one embodiment.

FIG. 2 is a side view of the robotic exoskeleton.

FIG. 3 is a schematic diagram of the application scenario of the robotic exoskeleton shown in FIGS. 1 and 2.

FIG. 4 is a schematic block diagram of the safety device according to one embodiment.

FIG. 5 is a schematic block diagram of the safety device according to another embodiment.

FIG. 6 is a schematic circuit diagram of the safety device according to one embodiment.

FIG. 7 is a schematic diagram of the first relay according to one embodiment, showing the normally closed port NC electrically connected to the common port C.

FIG. 8 is a schematic diagram of the first relay according to one embodiment, showing the normally open port NO electrically connected to the common port C.

FIG. 9 is a schematic flowchart of a method for emergency stop of a robotic exoskeleton according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

In one embodiment, a safety device for emergency stop of a robotic exoskeleton is installed outside a motor of the robotic exoskeleton. The safety device is used to prevent the motor of the robotic exoskeleton from rotating in the event of an unexpected power failure, control program error during operation, or when the user presses an emergency stop button. The resistance torque generated on the motor is sufficiently large to put the exoskeleton down slowly without damaging any mechanical components. In one embodiment, the motor can be a brushless DC motor (e.g., a brushless DC planetary gearbox motor) and the motor may have three-phase power lines.

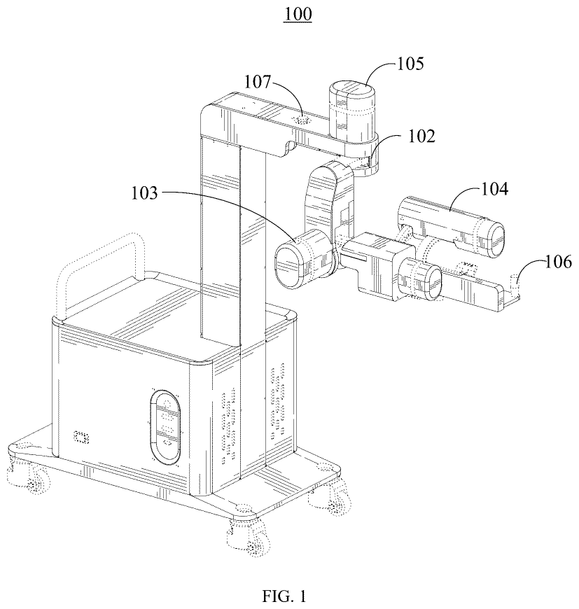

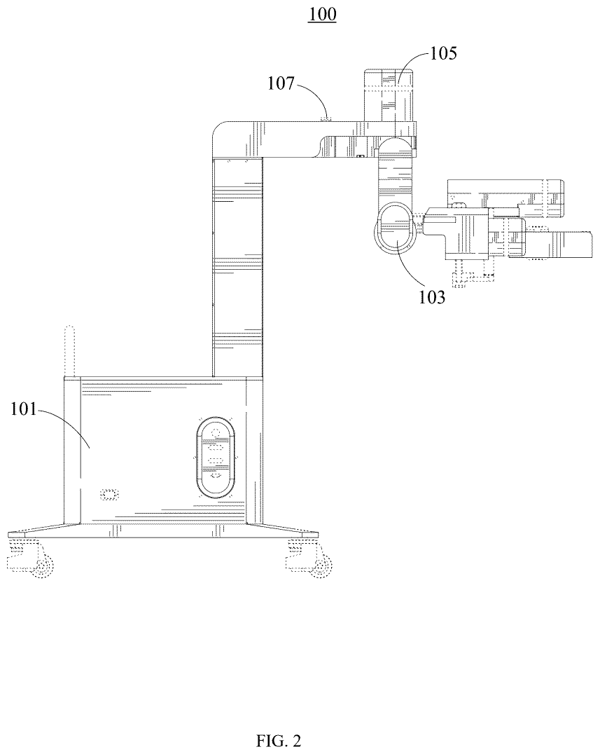

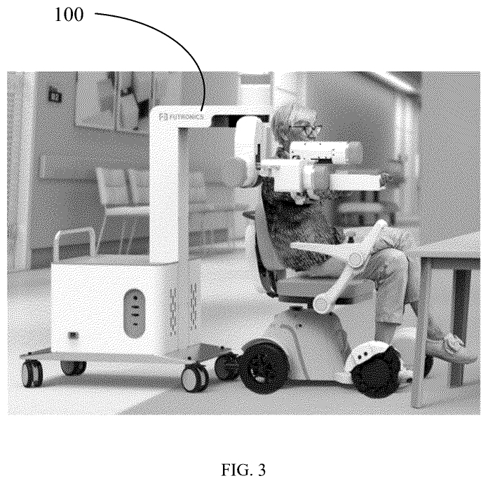

FIG. 1 is a schematic isometric view of a robotic exoskeleton according to one embodiment. FIG. 2 is a side view of the robotic exoskeleton. FIG. 3 is a schematic diagram of the application scenario of the robotic exoskeleton shown in FIGS. 1 and 2.

Referring to FIGS. 1-3, in one embodiment, the rotational joints of the robotic exoskeleton 100 have 4 degrees of freedom (DoF), which map to three joints on a human arm. The robotic exoskeleton 100 may include a base 101, a first rotary joint 102, a second rotary joint 103, a third rotary joint 104, and a fourth rotary joint 105. In one embodiment, a power supply is arranged in the base 101.

The first rotary joint 102 and the second rotary joint 103 correspond to human shoulder joints which are ball joints. The third rotary joint 104 corresponds to the human ulnar-humeral joint operating as a rotary joint. The fourth rotary joint 105 corresponds to the human elbow joint functioning as a hinge joint.

This robotic exoskeleton 100 is intended for use in physical therapy rehabilitation, facilitating muscle control improvement and preventing muscle atrophy in patients with disabilities. A human arm can be carried by the robotic exoskeleton 100 to perform instructed movements for rehabilitation training. The robotic exoskeleton 100 provides a power-assisted mode or a resistance mode based on the user's muscle control. In the power-assisted mode, the robotic exoskeleton 100 can help the human body stretch, while in the resistance mode, the robotic exoskeleton 100 can increase the intensity of exercise.

In one embodiment, the robotic exoskeleton 100 may further include an LED light 105 for indicating operations and a handle 106. In one embodiment, the safety device can be arranged in the second rotary joint 103. In one embodiment, the motor 300 is a brushless DC motor arranged in the second rotary joint 103 of the robotic exoskeleton 100.

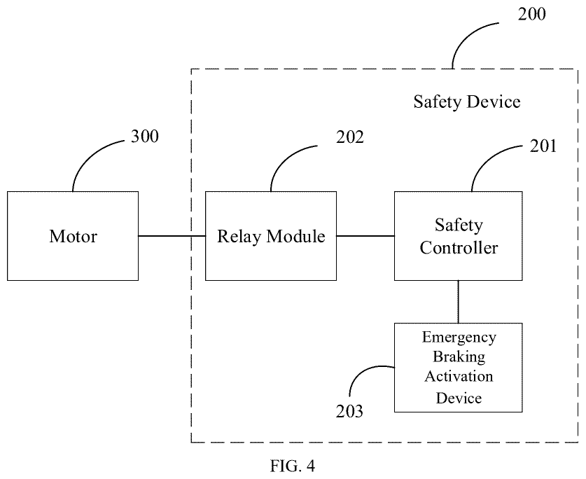

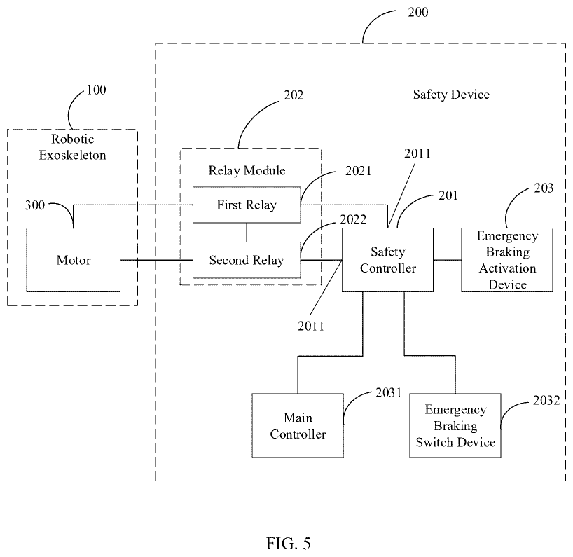

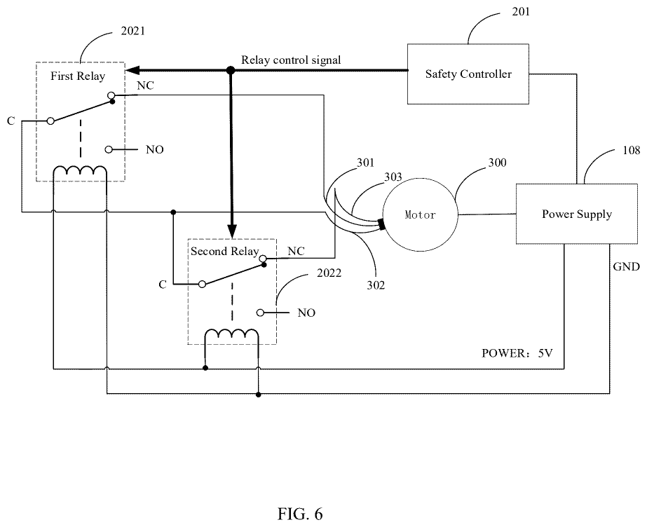

FIG. 4 is a schematic block diagram of the safety device according to one embodiment. FIG. 5 is a schematic block diagram of the safety device according to another embodiment. FIG. 6 is a schematic circuit diagram of the safety device according to one embodiment.

Referring to FIG. 4, a safety device 200 for emergency stop of the robotic exoskeleton is electrically connected to a motor 300 of the robotic exoskeleton 100. The safety device 200 may include a safety controller 201, a relay module 202 and an emergency braking activation device 203. The safety controller 201 is electrically connected to the emergency braking activation device 203 and the relay module 202. The relay module 202 is connected to the three-phase power lines of the motor 300. The safety controller 201 is to send a first relay control signal to the relay module 202 in response to receiving the braking signal sent by the emergency braking activation device 203 to control the relay module 202 to short-circuit the three-phase power lines of the motor 300. As a result, the motor 300 can be braked by short-circuiting the three-phase power lines.

With such configuration, the motor can be braked by short-circuiting the three-phase power lines, thereby realizing convenient and safe braking of the robotic exoskeleton. For motors without brakes, it can comply with the mandatory requirement that exoskeleton rehabilitation devices must have safety devices. For motors with brakes, it introduces additional safety measures to increase the reliability of exoskeleton use, while saving design and installation costs, reducing the difficulty of developing a braking system, and providing convenience for patients to obtain a safe robotic exoskeleton.

Referring to FIG. 5, in one embodiment, the relay module 202 may include a first relay 2021 and a second relay 2022. The first relay 2021 and the second relay 2022 may both be electromagnetic relays. In one embodiment, the signal input terminal 2011 of the safety controller 201 is connected to the first relay 2021 and the second relay 2022, and is to synchronously send the first relay control signal to the first relay 2021 and the second relay 2022.

The emergency braking activation device 203 may include a main controller 2031 and an emergency braking switch device 2032 that are arranged in the robotic exoskeleton 100. In one embodiment, one or more operation buttons 107 (see FIGS. 1 and 2) of the emergency braking switch device 2032 are exposed on the outer surface of the robotic exoskeleton 100. The operation buttons 107 can be referred to as emergency stop buttons. When a user presses one operation button 107, the emergency braking switch device 2032 can be triggered to send the braking signal. The braking signal is to brake the motor 300 by controlling the above-mentioned two relays.

In one embodiment, the main controller 2031 is to detect whether a control program error occurs, and send an emergency stop signal as the braking signal in response to detecting the control program error. The control program includes a control program for controlling various operations of the robotic exoskeleton 100, and includes a control program for controlling various operations of the safety device 200. In one embodiment, the emergency braking switch device 2032 is to send a stop signal as the braking signal in response to detecting a pressing operation thereon. The safety controller 201 continuously monitors the stop signal from the emergency braking switch device 2032 and the emergency stop signal from the main controller 2031.

Referring to FIG. 6, the three-phase power lines of the motor 300 include a first power line 301, a second power line 302 and a third power line 303. The three-phase power lines are respectively connected to the normally closed port NC of the first relay 2021, the normally closed port NC of the second relay 2022, and the common ports C of the first relay 2021 and the second relay 2022. Specifically, as shown in FIG. 6, the first power line 301 is connected to the normally closed port NC of the first relay 2021, the second power line 302 is connected to the common port C of the first relay 2021 and the common port C of the second relay 2022, and the third power line 303 is connected to the normally closed port NC of the second relay 2022.

In one embodiment, the first relay control signal is a low-level signal. Based on the low-level signal, the normally closed port NC of the first relay 2021 and the normally closed port NC of the second relay 2022 are in communication with each other. In this case, the normally closed port NC of the first relay 2021 is controlled to be electrically connected to the common port C of the first relay 2021, and the normally closed port NC of the second relay 2022 is controlled to be electrically connected to the common port C of the second relay 2022.

When the robotic exoskeleton 100 unexpectedly loses power, the main controller 2031 detects a control program error, or a user presses the emergency stop button on the robotic exoskeleton 100, the safety controller 201 will pull the signals to the two relays low so that the three-phase power lines of the brushless DC motor are directly, electrically connected to each other.

In one embodiment, the safety controller 201 may be configured to synchronously send a second relay control signal to the first relay 2021 and the second relay 2022 during standard operation to control the first relay 2021 and the second relay 2022 not to short-circuit the three-phase power lines of the motor 300, so that the motor 300 continues to rotate normally. Standard operation refers to an operation performed in periods when the robotic exoskeleton 100 does not require emergency braking, excluding situations such as unexpected power loss of the robotic exoskeleton 100, the main controller 2031 detecting a control program error, or a user pressing the emergency stop button on the robotic exoskeleton 100.

In one embodiment, the second relay control signal is a high-level signal. Based on the high-level signal, the normally open port NO of the first relay 2021 and the normally open port NO of the second relay 2021 are in communication with each other. In this case, the normally open port NO of the first relay 2021 is controlled to be electrically connected to the common port C of the first relay 2021, and the normally open port NO of the second relay 2022 is controlled to be electrically connected to the common port C of the second relay 2022.

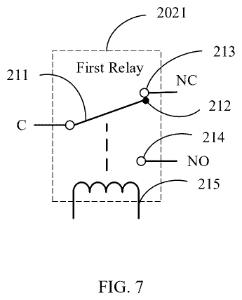

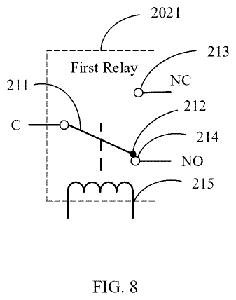

The operating principle of the two relays mentioned above is the same. Taking the first relay 2021 as an example, the operating principle diagram of the relay can be referred to FIGS. 7 and 8. The first relay 2021 includes an armature 211, a movable contact 212, a normally closed contact 213, a normally open contact 214 and a coil 215. In one embodiment, the e first relay 2021 is a relay with high-level trigger. As shown in FIG. 7, when the low-level signal is input to the first relay 2021, the coil 215 does not attract the armature 211, and the armature 211 causes the movable contact 212 to be in contact with the normally closed contact 213. Referring to FIG. 6, at this time, the first power line 301, the second power line 302 and the third power line 303 are directly connected to one another, thereby causing a short circuit and thus halting the operation of the motor 300. Referring to FIG. 8, when the high-level signal is input to the first relay 2021, the coil 215 attracts the armature 211, and the armature 211 drives the movable contact 212 to be in contact with the normally open contact 214. Referring to FIG. 6, at this time, the first power line 301, the second power line 302 and the third power line 303 are electrically connected to one another, avoiding any short circuit, and allowing the motor 300 to operate normally.

In one embodiment, the safety controller 201 is further configured to send the first relay control signal to the relay module 202 including the first relay 2021 and the second relay 2022 after a preset delay duration when receiving the braking signal. Setting the delay between receiving the braking signal and connecting the three-phase power lines together can meet the safety timing requirements of the electrical system. The preset duration can be customized by the user.

In one embodiment, the coil of the first relay 2021 and the coil of the second relay 2022 are electrically connected to each other. Safety device 200 may further include a power supply 108. The power supply 108 can be arranged in the base 101 of the robotic exoskeleton 100, and is electrically connected to the coil of the first relay 2021 and the coil of the second relay 2022.

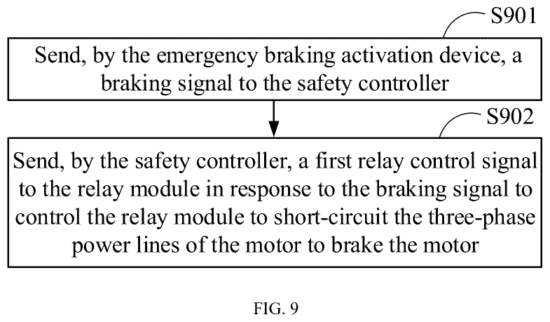

FIG. 9 is a schematic flowchart of a method for emergency stop of a robotic exoskeleton according to one embodiment. The method can realize emergency stop of the robotic exoskeleton as shown in FIGS. 1 and 2 through the safety device. The safety device includes a safety controller, a relay module and an emergency braking activation device. For specific structure details, please refer to the descriptions of the safety device 200 in FIGS. 4 to 6 mentioned above. In one embodiment, the method may include the following steps.

Step S901: Send, by the emergency braking activation device, a braking signal to the safety controller.

Step S902: Send, by the safety controller, a first relay control signal to the relay module in response to the braking signal to control the relay module to short-circuit the three-phase power lines of the motor to brake the motor.

The relay module and the emergency braking activation device are electrically connected to the safety controller. The relay module is electrically connected to three-phase power lines of the motor.

In one embodiment, the relay module may include a first relay and a second relay. The safety controller may include a signal input terminal that is connected to the first relay and the second relay. In one embodiment, step S902 includes: sending the first relay control signal synchronously to the first relay and the second relay.

In one embodiment, both of the first relay and the second relay includes a normally closed port NC and a common port C. The three-phase power lines are respectively connected to the normally closed port NC of the first relay, the normally closed port NC of the second relay, and the common ports C of the first relay and the second relay.

In one embodiment, the first relay control signal is a low-level signal, and the normally closed port NC of the first relay and the normally closed port NC of the second relay are controlled to be in communication with each other in response to the first relay and the second relay receiving the low-level signal.

In one embodiment, the method may further include: sending a second relay control signal to the first relay and the second relay synchronously during standard operation to control the first relay and the second relay not to short-circuit the three-phase power line of the motor, so that the motor operates normally.

In one embodiment, the second relay control signal is a high-level signal, and the normally open port NO of the first relay and the normally open port NO of the second relay are controlled to be in communication with each other in response to the first relay and the second relay receiving the high-level signal.

In one embodiment, the method may further include: sending, by the safety controller, the first relay control signal to the relay module after a preset delay duration in response to the safety controller receiving the braking signal.

In one embodiment, the emergency braking activation device may include a main controller and an emergency braking switch device arranged in the robotic exoskeleton. The emergency braking switch device includes a button that is exposed on an external surface of the robot exoskeleton.

In one embodiment, step S901 may include: detecting, by the main controller, whether a control program error occurs, and sending, by the main controller, the braking signal in response to the main controller detecting the control program error; or detecting, by the emergency brake switch device, whether a pressing operation occurs, and sending, by the emergency brake switch device, the braking signal in response to detecting the pressing operation.

For other technical, please refer to the relevant descriptions in the embodiments shown in FIGS. 1 to 8 as mentioned earlier, which will not be repeated here.

Another aspect of the present disclosure is directed to a non-transitory computer-readable medium storing instructions which, when executed, cause one or more processors to perform a method for emergency stop of a robotic exoskeleton. the method may include: in response to receiving a braking signal sent by the emergency brake activation device of the safety device, sending a first relay control signal to the relay module of the safety device to control the relay module to short-circuit three-phase power lines of the motor of the robotic exoskeleton so as to brake the motor. The relay module and the emergency braking activation device are electrically connected to the safety controller, and the relay module is electrically connected to three-phase power lines of the motor.

The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A safety device electrically connected to a motor of a robotic exoskeleton for implementing emergency stop of the robotic exoskeleton, the safety device comprising:
a safety controller;
a relay module electrically connected to the safety controller and three-phase power lines of the motor; and
an emergency braking activation device electrically connected to the safety controller;
wherein the safety controller is configured to send a first relay control signal to the relay module in response to receiving a braking signal sent by the emergency braking activation device, and the first relay control signal is configured to control the relay module to short-circuit the three-phase power lines of the motor to brake the motor.

2. The safety device of claim 1, wherein the relay module comprises a first relay and a second relay, the safety controller comprises a signal input terminal that is connected to the first relay and the second relay, and is configured to synchronously send the first relay control signal to the first relay and the second relay.

3. The safety device of claim 2, wherein both of the first relay and the second relay comprise a normally closed port and a common port, the three-phase power lines are respectively connected to the normally closed port of the first relay, the normally closed port of the second relay, and the common ports of the first relay and the second relay.

4. The safety device of claim 3, wherein the first relay control signal is a low-level signal, and the normally closed port of the first relay and the normally closed port of the second relay are controlled to be in communication with each other in response to the low-level signal.

5. The safety device of claim 2, wherein the safety controller is configured to synchronously send a second relay control signal to the first relay and the second relay during standard operation, and the second relay control signal is configured to control the first relay and the second relay not to short-circuit the three-phase power line of the motor, so that the motor operates normally.

6. The safety device of claim 5, wherein the second relay control signal is a high-level signal, and the normally open port of the first relay and the normally open port of the second relay are controlled to be in communication with each other in response to the high-level signal.

7. The safety device of claim 1, wherein the safety controller is further configured to send the first relay control signal to the relay module after a preset delay duration in response to receiving the braking signal.

8. The safety device of claim 1, wherein the emergency braking activation device comprises: a main controller and an emergency braking switch device arranged in the robotic exoskeleton, and the emergency braking switch device comprises a button that is exposed on an external surface of the robot exoskeleton;
the main controller is configured to detect whether a control program error occurs, and send the braking signal in response to detecting the control program error; and
the emergency brake switch device is configured to detect whether a pressing operation occurs, and send the braking signal in response to detecting the pressing operation.

9. The safety device of claim 2, wherein the first relay and the second relay each comprise a coil, and the coils of the first relay and the second relay are electrically connected to each other.

10. The safety device of claim 9, further comprising a power supply, wherein the robot exoskeleton comprises a base, the power supply is arranged in the base and electrically connected to the coils of the first relay and the second relay.

11. A computer-implemented method for emergency stop of a robotic exoskeleton that comprises a motor, the method comprising:
providing a safety device electrically connected to the motor of the robotic exoskeleton, wherein the safety device comprises a safety controller, a relay module and an emergency braking activation device that are electrically connected to the safety controller, the relay module is electrically connected to three-phase power lines of the motor;
sending, by the emergency braking activation device, a braking signal to the safety controller; and
sending, by the safety controller, a first relay control signal to the relay module in response to the braking signal to control the relay module to short-circuit the three-phase power lines of the motor to brake the motor.

12. The method of claim 11, wherein the relay module comprises a first relay and a second relay, the safety controller comprises a signal input terminal that is connected to the first relay and the second relay; sending the first relay control signal to the relay module comprises: sending the first relay control signal synchronously to the first relay and the second relay.

13. The method of claim 12, wherein both of the first relay and the second relay comprise a normally closed port and a common port, the three-phase power lines are respectively connected to the normally closed port of the first relay, the normally closed port of the second relay, and the common ports of the first relay and the second relay.

14. The method of claim 13, wherein the first relay control signal is a low-level signal, and the normally closed port of the first relay and the normally closed port of the second relay are controlled to be in communication with each other in response to the first relay and the second relay receiving the low-level signal.

15. The method of claim 12, further comprising: sending a second relay control signal to the first relay and the second relay synchronously during standard operation to control the first relay and the second relay not to short-circuit the three-phase power line of the motor, so that the motor operates normally.

16. The method of claim 15, wherein the second relay control signal is a high-level signal, and the normally open port of the first relay and the normally open port of the second relay are controlled to be in communication with each other in response to the first relay and the second relay receiving the high-level signal.

17. The method of claim 11, further comprising: sending, by the safety controller, the first relay control signal to the relay module after a preset delay duration in response to the safety controller receiving the braking signal.

18. The method of claim 11, wherein the emergency braking activation device comprises: a main controller and an emergency braking switch device arranged in the robotic exoskeleton, and the emergency braking switch device comprises a button that is exposed on an external surface of the robot exoskeleton;
sending, by the emergency braking activation device, the braking signal to the safety controller comprises:
detecting, by the main controller, whether a control program error occurs, and sending, by the main controller, the braking signal in response to the main controller detecting the control program error; or
detecting, by the emergency brake switch device, whether a pressing operation occurs, and sending, by the emergency brake switch device, the braking signal in response to detecting the pressing operation.

19. A non-transitory computer-readable storage medium storing instructions that, when executed by at least one processor of a safety device electrically connected to a motor of a robotic exoskeleton and comprising a safety controller, a relay module and an emergency braking activation device, cause the at least one processor to perform a method for emergency stop of the robotic exoskeleton, the method comprising:
in response to receiving a braking signal sent by the emergency brake activation device of the safety device, sending a first relay control signal to the relay module of the safety device to control the relay module to short-circuit three-phase power lines of the motor of the robotic exoskeleton so as to brake the motor;
wherein the relay module and the emergency braking activation device are electrically connected to the safety controller, and the relay module is electrically connected to three-phase power lines of the motor.
